(19) United States
(12) Patent Application Publication
(10) Pub. No.: US 2026/0029796 A1
(43) Pub. Date: Jan. 29, 2026

(54) Enhanced Connectivity System For Drones

(71) Applicant: Skydio, Inc., San Mateo, CA (US)

(72) Inventors: Oleg Tolstov, San Mateo, CA (US); Eyal Hochdorf, Palo Alto, CA (US); Abraham Galton Bachrach, Emerald Hills, CA (US)

(21) Appl. No.: 19/280,234

(22) Filed: Jul. 25, 2025

Related U.S. Application Data
(60) Provisional application No. 63/675,655, filed on Jul. 25, 2024.

(51) Int. Cl. G05D 1/606; B64U 10/14; B64U 50/13; B64U 50/19; B64U 101/30; G05D 109/25; H04W 4/40; H04W 24/08

(52) U.S. Cl. CPC G05D 1/606; H04W 4/40; H04W 24/08; B64U 10/14; B64U 50/13; B64U 50/19; B64U 2101/30; B64U 2201/104; G05D 2109/254

(57) ABSTRACT

Disclosed is a multi-modal communication system for unmanned aerial vehicles (UAVs) that integrates multiple wireless interfaces, such as point-to-point (P2P) wireless links and cellular links, to ensure seamless connectivity during flight. The system dynamically selects between wireless interfaces based on known, predicted or real-time link quality, plans a flight path based on a connectivity map and adapts flight paths in real-time. The system adapts to changing link quality. Adaptive responses include modifying a flight path, backtracking to a last known location with satisfactory signal coverage, RF channel switching in P2P link, and suspending video transmission while maintaining control links. A machine learning model predicts link conditions based on environmental conditions and historical data. The system may also leverage remote access points with Ethernet or satellite backhaul to extend coverage. These features provide resilient, autonomous communication for UAV operations in variable RF environments, improving reliability over traditional fixed-path, single-link systems.

### CROSS-REFERENCE TO RELATED APPLICATION(S)

This application claims the benefit of U.S. Provisional Patent Application No. 63/675,655, filed Jul. 25, 2024, the entire disclosure of which is hereby incorporated by reference.

### TECHNICAL FIELD

This disclosure relates to unmanned aerial vehicles (UAVs), and more specifically, to UAVs with multi-modal wireless connectivity and autonomous link management.

### BACKGROUND

The advent of drones or unmanned aerial vehicles (UAVs) has revolutionized various sectors, including telecommunications and computer networks. Drones are increasingly being used for applications such as package delivery, surveillance, and disaster response, among others that require real-time, persistent communication between the UAV and a ground-based controller. These applications demand reliable and continuous connectivity to ensure the safe and efficient operation of drones, especially in complex environments where signal integrity is crucial. Traditional connectivity solutions often rely on a single mode of communication, which can be susceptible to disruptions due to interference, physical obstructions, or limited coverage areas.

The increasing complexity of urban landscapes and the need for drones to operate in diverse environments have highlighted the limitations of existing connectivity architectures. While there have been many success stories using traditional line-of-sight drone operations, these earlier systems have relied on point-to-point radio connectivity (e.g., IEEE 802.11 (Wi-Fi) protocols) that could achieve several miles of range in flat, rural settings, but would easily lose connection once obstacles such as buildings, hills, and trees get in the way.

The complex needs of scaled Drone as First Responder (DFR) initiatives-which can include flying a drone low and behind buildings, peering around corners, passing through a forest, following a subject for miles across town or even cresting over a mountain ridge-will not be met by even the best point-to-point solutions. As drones are deployed in more challenging scenarios, such as navigating through dense urban areas or responding to emergencies in remote locations, the risk of connectivity loss becomes a significant concern. Relying on a single mode of connectivity has severe limitations in many drone applications. These and other drawbacks exist.

### SUMMARY

In some aspects, the techniques described herein relate to a drone communication system, including: a drone with multiple wireless communication interfaces; a memory storing a connectivity map having expected wireless link quality across geographic regions for the wireless communication interfaces; a link management module configured to: dynamically select between the wireless communication interfaces based on at least one of the connectivity map or real-time wireless link quality during flight; and an autonomy engine onboard the drone configured to: plan a flight path based on the connectivity map, monitor real-time wireless link quality during flight, and modify the flight path during flight in response to detecting a wireless connectivity in a region is below a specified threshold.

In some aspects, the techniques described herein relate to a method for managing a drone mission based on wireless connectivity, the method including: accessing, from a memory onboard a drone, a connectivity map having expected wireless link coverage across geographic regions for a plurality of wireless communication interfaces on the drone; generating, by an autonomy engine on board the drone, a flight path based on the connectivity map; automatically switching between the wireless communication interfaces during flight based on the connectivity map or real-time wireless link quality; and modifying the flight path in response to detecting that a wireless connectivity in a region along the flight path is below a specified threshold.

In some aspects, the techniques described herein relate to an autonomous unmanned aerial vehicle (UAV) including: a point-to-point (P2P) wireless radio transceiver and a cellular transceiver; a memory storing a connectivity map indicating expected wireless link coverage across geographic regions; and an autonomy engine configured to: plan a flight path based on a mission objective and the connectivity map, monitor real-time wireless link quality during flight, dynamically reroute the UAV to maintain wireless connectivity by avoiding regions with the wireless link quality below a specified threshold, and in response to loss of both P2P wireless link and cellular wireless link for a predefined duration, backtrack the UAV to a last known location with the wireless link quality above the specified threshold.

Various other aspects, features, and advantages of the disclosed embodiments will be apparent through the detailed description and the drawings attached hereto. It is also to be understood that both the foregoing general description and the following detailed description are examples, and not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification “a portion,” refers to a part of, or the entirety of (i.e., the entire portion), a given item (e.g., data) unless the context clearly dictates otherwise.

### BRIEF DESCRIPTION OF THE DRAWINGS

FIG. 1 illustrates an example configuration of a top side of an unmanned aerial vehicle (UAV), consistent with various embodiments.

FIG. 2 illustrates an example configuration of a bottom side of the UAV, consistent with various embodiments.

FIG. 3 illustrates an example UAV architecture, consistent with various embodiments.

FIG. 4 illustrates a drone communication system configured for multi-modal connectivity and autonomous mission management, consistent with various embodiments.

FIG. 5 illustrates additional details of connectivity-aware flight path planning and adaptive rerouting, consistent with various embodiments.

FIG. 6 illustrates an adaptive response mechanism in which a drone modulates data transmission behavior based on available link conditions, consistent with some embodiments.

FIG. 7 illustrates an example of dynamic channel selection performed by the link management module, consistent with various embodiments.

FIG. 8 is a flowchart illustrating a method for connectivity-aware adaptive flight management, consistent with various embodiments.

Embodiments will now be described in detail with reference to the drawings, which are provided as illustrative examples so as to enable those skilled in the art to practice the embodiments. Notably, the figures and examples below are not meant to limit the scope to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the embodiments will be described, and detailed descriptions of other portions of such known components will be omitted so as not to obscure the description of the embodiments. In the present specification, an embodiment showing a singular component should not be considered limiting; rather, the scope is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the scope encompasses present and future known equivalents to the components referred to herein by way of illustration.

### DETAILED DESCRIPTION

Disclosed are embodiments for a multi-modal drone communication system that integrates multiple wireless communication interfaces, such as point-to-point (P2P) wireless links and cellular communication links, enabling seamless and resilient connectivity during flight. The communication system includes a drone equipped with multiple wireless communication interfaces and a link management module configured to dynamically select the optimal communication interface based on either real-time link quality or a precomputed connectivity map, which stores expected link quality across geographic regions. The multi-modal connectivity architecture allows the drone to maintain robust command-and-control and data streaming capabilities across varied environments, such as urban, rural, or obstructed terrain, by automatically transitioning between P2P and cellular networks without interrupting mission-critical functions.

The communication system further includes an onboard autonomy engine that utilizes the connectivity map to plan the flight path and monitor real-time wireless link metrics during operation. In response to detecting degraded connectivity conditions or changes in link performance metrics, the autonomy engine may initiate a range of adaptive responses. These include rerouting the flight path to avoid predicted coverage dead zones, backtracking to the last known region with acceptable connectivity, suspending or reducing video transmission bandwidth while maintaining command signals, dynamically selecting a less congested communication channel for the P2P link, or transmitting alternate route suggestions to a controller for display to a human operator in non-autonomous missions. These features collectively ensure mission continuity and operator situational awareness even in challenging radio-frequency (RF) environments.

The communication system may further include one or more remote access points configured to broadcast point-to-point signals and relay drone communication. The access points may be connected to a wide area network (WAN) via Ethernet or satellite backhaul. These access points may be deployed in the field, independent of the operator's location, enabling greater physical separation between the operator and the drone to enhance operational safety, particularly in high-risk environments. The access points may also be used to extend network coverage in areas with poor cellular connectivity, thereby increasing mission range and flexibility.

The disclosed embodiments offer significant advantages over conventional systems that rely solely on line-of-sight P2P communication or static routing logic. Moreover, unlike commercial mesh radios or bonded-link solutions that simply combine physical interfaces or rely on operator-side routing logic (e.g., VPN bonding or MPTCP), the disclosed system integrates autonomy logic to adapt flight behavior, not just link use. The drone may actively reroute itself to sustain mission-critical links using predictive, mission-aware decision making. This level of integration between navigation and connectivity adaptation distinguishes the system from traditional mesh or RF redundancy solutions. For example, by providing multi-modal connectivity that seamlessly fuses P2P and cellular links, the communication system can dynamically select the most reliable communication path at any given time, thereby mitigating disconnection risks inherent in single-link systems. In another example, by providing autonomous link management based on predicted and real-time connectivity data, the drone can proactively reroute or adjust its behavior to maintain mission continuity without requiring operator intervention. Additionally, by incorporating remote access points with backhaul capability, the communication system enables extended-range deployments and improves operator safety by decoupling the operator's physical location from the active RF transmission site. Collectively, these capabilities provide significant improvements in robustness, flexibility, and reliability over prior art drone communication systems that rely solely on line-of-sight links or static routing approaches. The multi-modal connectivity and autonomous link management capabilities improve operational range, resilience, and reliability, particularly for high-stakes applications such as public safety, emergency response, and defense missions, where uninterrupted connectivity and adaptive mission management are critical.

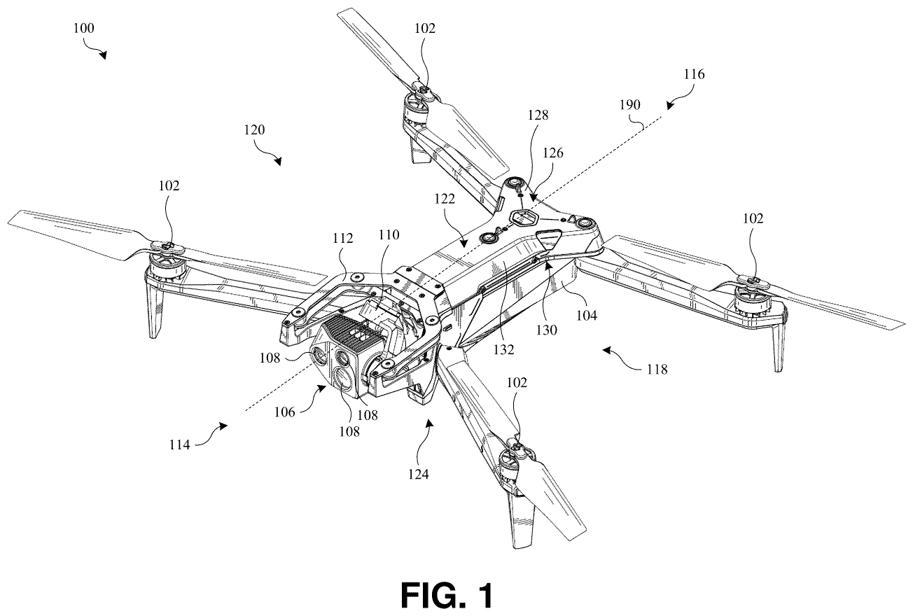

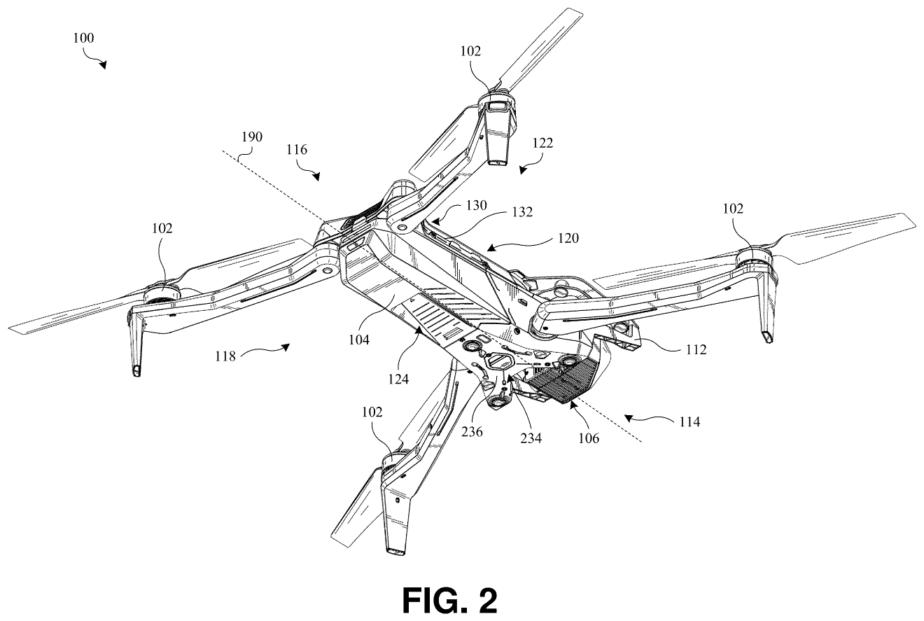

Turning now to the figures, FIG. 1 illustrates a top perspective view of an unmanned aerial vehicle (UAV) 100. FIG. 2 illustrates a bottom perspective view of the UAV 100.

The UAV 100 may include one or more propulsion mechanisms 102 and a power source, such as a battery coupled to the UAV 100. The UAV 100 may be configured for autonomous landing and/or docking with a docking station. To support the autonomous landing and/or docking, the UAV 100 may follow any suitable processes or procedures, or may include one or more components, such as those described in U.S. application Ser. No. 16/991,122, filed Aug. 12, 2020, and U.S. Provisional Application No. 63/527,261, filed on Jul. 17, 2023, the entire disclosures of which are hereby incorporated by reference for all purposes.

The propulsion mechanisms 102 may include any components and/or structures suitable for supporting flight of the UAV 100. For example, as shown in FIGS. 1 and 2, the propulsion mechanisms 102 may be or may include propeller assemblies having one or more blades connected to hubs of the UAV 100. The one or more blades may be propelled by a motor to rotate the one or more blades and facilitate flight of the UAV 100, whereby the motor may be powered by a power source of the UAV 100, such as the battery 104. It should be appreciated, however, that the configuration and/or structure of the UAV 100 may vary depending on the particular configuration of the UAV 100, and as such, the UAV 100 shown in FIG. 1 is not intended to limit the structure of the UAV 100.

As mentioned above, the UAV 100 may be configured using various processes or protocols to autonomously land (e.g., on a docking station), to autonomously take flight (e.g., from a docking station), or both. To facilitate autonomous landing and/or autonomous flight, the UAV 100 may include one or more sensors, such as image sensors, that are configured to monitor a position of the UAV 100 and/or detect a specified image, such as a fiducial disposed on a docking station. For example, during a landing sequence (e.g., a docking sequence) of the UAV 100, the image sensors of the UAV 100 may detect an image, such as the fiducial disposed on the docking station, to properly align and guide the UAV 100 to dock.

The UAV 100 may further include a camera system 106. The camera system 106 may be configured to detect, monitor, capture, record, or a combination thereof one or more images. The camera system 106 may be configured to facilitate autonomous or user-controlled flight of the UAV 100. For example, the camera system 106 may include one or more cameras 108. The cameras 108 may capture a live feed of an environment during flight, whereby a user via a user interface (e.g., a controller) may control the UAV 100 based upon the live feed of the environment. Alternatively, or additionally, the cameras 108 may capture images of the environment and/or monitor the environment in real-time to autonomously fly through the environment. It should be noted that the cameras 108 and the camera system 106 are not limited to any particular configuration, and any types of camera configurations (e.g., wide-angle, high-resolution, etc.) may be implemented in the UAV 100.

The camera system 106 may be operable via a gimbal system 110 coupled to the camera system 106. The gimbal system 110 may be configured to be controlled autonomously or via a user interface (e.g., a controller) to orient or otherwise move the camera system 106 (e.g., the cameras 108) relative to the UAV 100. The gimbal system 110 may include one or more arms and one or more pivot joints that facilitate movement of the camera system 106 relative to the UAV 100.

The gimbal system 110 and the camera system 106 may be coupled to the UAV 100 by a mounting bracket 112. The mounting bracket 112 may be coupled to the UAV 100 by one or more fasteners or other mechanical connection means to secure the gimbal system 110 and the camera system 106 to the UAV 100. The mounting bracket 112 may be coupled to any portion of the UAV 100. By way of example, as shown in FIGS. 1 and 2, the mounting bracket 112 may be coupled to a front 114 (i.e., a front side) of the UAV 100 or a top 122 (i.e., a top side) of the UAV 100 such that the camera system 106 may be positioned in the front 114 of the UAV 100.

That is, the camera system 106 may be located at the front 114 (i.e., the front side) of the UAV 100 so that the cameras 108 may capture an environment in front of the UAV 100 with respect to a forward direction of travel of the UAV 100 (e.g., a direction of travel of the UAV 100 that is substantially parallel to the ground or along the ground). However, in certain configurations, the camera system 106 may also be coupled to another portion of the UAV 100, such as a rear 116 (i.e., rear side) of the UAV 100, a first side 118 of the UAV 100, a second side 120 of the UAV 100, a bottom 124 (i.e., a bottom side) of the UAV 100, or a combination or variation thereof.

As discussed in further detail below, one or more attachments may be coupled to the UAV 100 and operable with the UAV 100 to further customize a user experience of the UAV 100. That is, the one or more attachments may be coupled to the UAV 100 to provide additional functionality to the UAV 100. For example, the one or more attachments may be a global positioning system (GPS) attachment, a microphone and/or speaker attachment, a night vision attachment (e.g., infrared (IR) attachment), a spotlight attachment, a secondary power source attachment (e.g., a secondary battery similar to the battery 104), an antenna or other radio accessory, a secondary camera system similar to or different from the camera system 106, a computer module, or a combination thereof. Thus, it is envisioned that any type of attachments or arrangement of multiple attachments may be configured for securement to the UAV 100. Additionally, as discussed in further detail below, the UAV 100 or a system thereof may be dynamic such that one or more characteristics (e.g., features, functionalities, operations, etc.) of the UAV 100 may be automatically and dynamically adjusted based upon a type of attachment coupled to the UAV 100.

To facilitate coupling one or more attachments to the UAV 100, the UAV 100 may include one or more attachment interfaces. As shown in FIGS. 1 and 2, the UAV 100 may include a plurality of attachment interfaces located on the UAV 100. For example, the UAV 100 may include a top attachment interface 126 located on the top 122 (i.e., the top side) of the UAV 100, a side attachment interface 130 located on the first side 118 of the UAV 100, a side attachment interface 130 located on the second side 120 of the UAV 100 that opposes the first side 118, and a bottom attachment interface 234 located on the bottom 124 (i.e., the bottom side) of the UAV 100.

To further illustrate positioning of such attachment interfaces, as shown in FIGS. 1 and 2, the UAV 100 (e.g., a body of the UAV 100 from which the propulsion mechanisms 102 extend) may extend along a longitudinal axis 190 of the UAV 100 from the front 114 of the UAV 100 to the rear 116 of the UAV 100. That is, the UAV 100 may extend from a first end (e.g., the front 114, which may be considered a forward end of the UAV 100) to an opposing second end (e.g., the rear 116, which may be considered an aft end of the UAV 100) along the longitudinal axis 190, whereby a length of the UAV 100 or a body thereof may be measured from the first end to the second end.

Moreover, the first side 118 of the UAV 100 may oppose the second side 120 of the UAV 100 with respect to the longitudinal axis 190. The first side 118 and second side 120 may be located on opposing sides of the longitudinal axis 190. The first side 118 may be considered a port side of the UAV 100 and the second side 120 may be considered a starboard side of the UAV 100.

Based on the above relative orientations, it can be seen in FIGS. 1 and 2 that the attachment interfaces described above may be positioned in various locations with respect to the longitudinal axis 190 of the UAV 100. For example, the top attachment interface 126 and/or the bottom attachment interface 234 may be located on the top 122 (i.e., the top side) of the UAV 100 and may extend along the longitudinal axis 190 between the first end (e.g., the front 114 or forward end) and the second end (e.g., the rear 116 or aft end) of the UAV 100. Additionally, the side attachment interfaces 130 may be located on the first side 118 and the second side 120 of the UAV 100 such that the side attachment interfaces 130 may be located on opposing sides of the longitudinal axis 190. That is, a first one of the side attachment interfaces 130 may be located on the port side (e.g., the first side 118) of the UAV 100 and a second one of the side attachment interfaces 130 may be located on the starboard side (e.g., the second side 120) of the UAV 100 such that the side attachment interfaces 130 are located on opposing sides of the longitudinal axis 190.

It should be noted that the above relative orientations associated with the UAV 100 are provided for illustrative purposes and should not be construed as limiting the teachings herein. For example, although the front 114 of the UAV 100 may be considered the front end of the UAV 100 and the rear 116 of the UAV 100 may be considered the aft end of the UAV 100, such considerations do not mean that the UAV 100 only travels in a forward direction with the front 114 of the UAV 100 leading the travel. That is, the UAV 100 may travel in any direction (e.g., fore, aft, side-to-side between the port and starboard sides, in an elevational direction, etc.) with respect to the longitudinal axis 190.

Turning now back to the attachment interfaces, it should be noted that such attachment interfaces may be integrated into the UAV 100, such as a housing of the UAV 100, or may be connected to the UAV 100 to allow for attachment of various attachments. That is, the attachment interfaces may provide a connection means to easily and removably couple various attachments to the UAV 100.

By way of example, the top attachment interface 126 may include a top attachment surface 128. The top attachment surface 128 may be located on, or formed with, the top (i.e., the top side) of the UAV 100. The top attachment surface 128 may be configured to receive, support, or otherwise couple to—either directly or indirectly—various attachments. Similarly, the side attachment interfaces 130 may include a side attachment surface 132 located on, or formed with, the first side 118 and/or the second side 120 of the UAV 100. Moreover, the bottom attachment interface 234 may include a bottom attachment surface 236 located on, or formed with, the bottom 124 (i.e., the bottom side) of the UAV 100. Any number of these attachment surfaces may exist for any of the attachment interfaces. That is, an attachment interface may include more than one attachment surface (e.g., a first attachment surface and a second attachment surface).

Based on the above, one or more attachments may be coupled to the top 122 of the UAV 100, the bottom 124 of the UAV 100, the first side 118 of the UAV 100, the second side 120 of the UAV 100, or a combination thereof. Additionally, it is envisioned that the front 114 and/or the rear 116 of the UAV 100 may also in certain configurations include an additional attachment interface. For example, in certain configurations the UAV 100 may remove the camera system 106 from the front 114 of the UAV and couple the camera system 106 to the UAV 100 in another location (e.g., the rear 116). In such a configuration, the front 114 may include an attachment interface for further attachments.

It should also be noted that the attachment interfaces of the UAV 100 may be adapted for universal or common attachment techniques. That is, various types of attachments may be coupled to the same attachment interface. For example, the GPS attachment and the night vision attachment may both be configured to attach to the top attachment interface 126 and the bottom attachment interface 234. Additionally, more than one attachment may be coupled to the UAV 100 at one time and may be powered by the power source (e.g., the battery 104) of the UAV 100. For example, a first attachment (e.g., a GPS attachment) may be coupled to the top attachment interface 126 and a second attachment (e.g., a spotlight attachment) may be coupled to the side attachment interface 130 located on the first side 118 of the UAV 100. Moreover, the attachment interfaces may include one or more additional features, such as heat-sinking components or other cooling components. Based on the above, various configurations and customization may be possible.

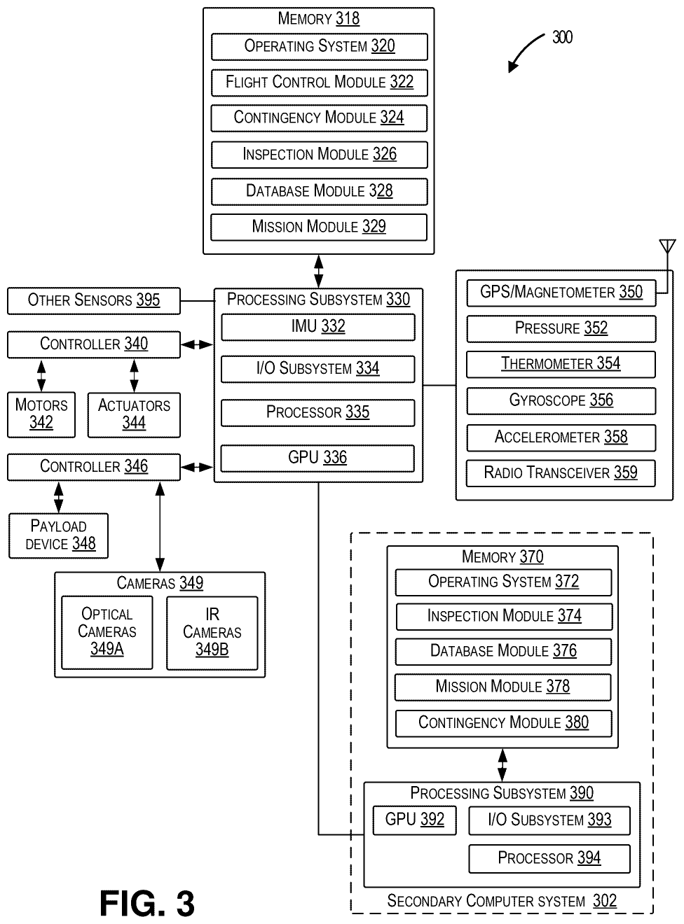

FIG. 3 illustrates an example UAV architecture, consistent with various embodiments. In the examples herein, the UAV 100 may sometimes be referred to as a “drone” and may be implemented as any type of UAV capable of controlled flight without a human pilot onboard. For instance, the UAV 100 may be controlled autonomously by one or more onboard processors, such as processor 335, that execute one or more executable programs. Additionally, or alternatively, the UAV 100 may be controlled via a remote controller, such as through a remotely located controller operated by a human pilot and/or controlled by an executable program executing on or in cooperation with the controller.

A UAV can include a primary computer system 300 and a secondary computer system 302. The UAV primary computer system 300 can be a system of one or more computers, or software executing on a system of one or more computers, which is in communication with, or maintains, one or more databases. The UAV primary computer system 300 can include a processing subsystem 330 including one or more processors 335, graphics processing units 336, I/O subsystem 334, and an inertial measurement unit (IMU) 332. In addition, the UAV primary computer system 300 can include logic circuits, analog circuits, associated volatile and/or non-volatile memory, associated input/output data ports, power ports, etc., and include one or more software processes executing on one or more processors or computers. The UAV primary computer system 300 can include memory 318.

Memory 318 may include non-volatile memory, such as one or more magnetic disk storage devices, solid-state hard drives, or flash memory. Other volatile memory such as RAM, DRAM, SRAM may be used for temporary storage of data while the UAV is operational. Databases may store information describing UAV flight operations, flight plans, contingency events, geofence information, component information and other information.

The UAV primary computer system 300 may be coupled to one or more sensors, such as global navigation satellite system (GNSS) receivers 350 (e.g., GPS receivers), thermometer 354, gyroscopes 356, accelerometers 358, pressure sensors (static or differential) 352, and other sensors 395 that capture perception inputs of a physical environment. The other sensors 395 can include current sensors, voltage sensors, magnetometers, hydrometers, anemometers and motor sensors. The UAV may use IMU 332 in inertial navigation of the UAV. Sensors can be coupled to the UAV primary computer system 300, or to controller boards coupled to the UAV primary computer system 300. One or more communication buses, such as a controller area network (CAN) bus, or signal lines, may couple the various sensor and components.

Various sensors, devices, firmware and other systems may be interconnected to support multiple functions and operations of the UAV. For example, the UAV primary computer system 300 may use various sensors to determine the UAV's current geo-spatial position, attitude, altitude, velocity, direction, pitch, roll, yaw and/or airspeed and to pilot the UAV along a specified flight path and/or to a specified location and/or to control the UAV's attitude, velocity, altitude, and/or airspeed (optionally even when not navigating the UAV along a specific flight path or to a specific location).

The flight control module 322 handles flight control operations of the UAV. The module interacts with one or more controllers 340 that control operation of motors 342 and/or actuators 344. For example, the motors may be used for rotation of propellers, and the actuators may be used for flight surface control such as ailerons, rudders, flaps, landing gear and parachute deployment.

The contingency module 324 monitors and handles contingency events. For example, the contingency module 324 may detect that the UAV has crossed a boundary of a geofence, and then instruct the flight control module 322 to return to a predetermined landing location. The contingency module 324 may detect that the UAV has flown or is flying out of a visual line of sight (VLOS) from a ground operator, and instruct the flight control module 322 to perform a contingency action, e.g., to land at a landing location. Other contingency criteria may be the detection of a low battery or fuel state, a malfunction of an onboard sensor or motor, or a deviation from the flight plan. The foregoing is not meant to be limiting, as other contingency events may be detected. In some instances, if equipped on the UAV, a parachute may be deployed if the motors or actuators fail.

The mission module 329 processes the flight plan, waypoints, and other associated information with the flight plan as provided to the UAV in a flight package. The mission module 329 works in conjunction with the flight control module 322. For example, the mission module may send information concerning the flight plan to the flight control module 322, for example waypoints (e.g., latitude, longitude and altitude), flight velocity, so that the flight control module 322 can autopilot the UAV.

The UAV may have various devices connected to the UAV for performing a variety of tasks, such as data collection. For example, the UAV may carry one or more cameras 349. Cameras 349 can include one or more visible light cameras 349A, which can be, for example, a still image camera, a video camera, or a multispectral camera. The UAV may carry one or more infrared cameras 349B. Each infrared camera 349B can include a thermal sensor configured to capture one or more still or motion thermal images of an object, e.g., a solar panel. In addition, the UAV may carry a Lidar, radio transceiver, sonar, and traffic collision avoidance system (TCAS). Data collected by the devices may be stored on the device collecting the data, or the data may be stored on non-volatile memory 318 of the UAV primary computer system 300.

The UAV primary computer system 300 may be coupled to various radios, e.g., transceivers 359 for manual control of the UAV, and for wireless or wired data transmission to and from the UAV primary computer system 300, and optionally a UAV secondary computer system 302. The UAV may use one or more communications subsystems, such as a wireless communication or wired subsystem, to facilitate communication to and from the UAV. Wireless communication subsystems may include radio transceivers, infrared, optical ultrasonic and electromagnetic devices. Wired communication systems may include ports such as Ethernet ports, USB ports, serial ports, or other types of port to establish a wired connection to the UAV with other devices, such as a ground control station (GCS), flight planning system (FPS), or other devices, for example a mobile phone, tablet, personal computer, display monitor, other network-enabled devices. The UAV may use a lightweight tethered wire to a GCS for communication with the UAV. The tethered wire may be affixed to the UAV, for example via a magnetic coupler.

The UAV can generate flight data logs by reading various information from the UAV sensors and operating system 320 and storing the information in computer-readable media (e.g., non-volatile memory 318). The data logs may include a combination of various data, such as time, altitude, heading, ambient temperature, processor temperatures, pressure, battery level, fuel level, absolute or relative position, position coordinates (e.g., GPS coordinates), pitch, roll, yaw, ground speed, humidity level, velocity, acceleration, and contingency information. The foregoing is not meant to be limiting, and other data may be captured and stored in the flight data logs. The flight data logs may be stored on a removable medium. The medium can be installed on the ground control system or onboard the UAV. The data logs may be wirelessly transmitted to the ground control system or to the FPS.

Modules, programs or instructions for performing flight operations, contingency maneuvers, and other functions may be performed with operating system 320. In some implementations, the operating system 320 can be a real time operating system (RTOS), UNIX, LINUX, OS X, WINDOWS, ANDROID or other operating system 320. Additionally, other software modules and applications may run on the operating system 320, such as a flight control module 322, contingency module 324, inspection module 326, database module 328 and mission module 329. In particular, inspection module 326 can include computer instructions that, when executed by processor 335, can cause processor 335 to control the UAV to perform solar panel inspection operations as described below. Typically, flight critical functions will be performed using the UAV primary computer system 300. Operating system 320 may include instructions for handling basic system services and for performing hardware dependent tasks.

In addition to the UAV primary computer system 300, the secondary computer system 302 may be used to run another operating system 372 to perform other functions. The UAV secondary computer system 302 can be a system of one or more computers, or software executing on a system of one or more computers, which is in communication with, or maintains, one or more databases. The UAV secondary computer system 302 can include a processing subsystem 390 of one or more processors 394, GPU 392, and I/O subsystem 393. The UAV secondary computer system 302 can include logic circuits, analog circuits, associated volatile and/or non-volatile memory, associated input/output data ports, power ports, etc., and include one or more software processes executing on one or more processors or computers. The UAV secondary computer system 302 can include memory 370. Memory 370 may include non-volatile memory, such as one or more magnetic disk storage devices, solid-state hard drives, flash memory. Other volatile memory such a RAM, DRAM, SRAM may be used for storage of data while the UAV is operational.

Ideally, modules, applications and other functions running on the secondary computer system 302 will be non-critical functions in nature. If the function fails, the UAV will still be able to operate safely. The UAV secondary computer system 302 can include operating system 372. In some implementations, the operating system 372 can be based on real time operating system (RTOS), UNIX, LINUX, OS X, WINDOWS, ANDROID or other operating system.

Additionally, other software modules and applications may run on the operating system 372, such as an inspection module 374, database module 376, mission module 378 and contingency module 380. In particular, inspection module 374 can include computer instructions that, when executed by processor 394, can cause processor 394 to control the UAV to perform solar panel inspection operations as described below. Operating system 372 may include instructions for handling basic system services and for performing hardware dependent tasks.

The UAV can include controllers 346. Controllers 346 may be used to interact with and operate a payload device 348, and other devices such as cameras 349A and 349B. Cameras 349A and 349B can include a still-image camera, video camera, infrared camera, multispectral camera, stereo camera pair. In addition, controllers 346 may interact with a Lidar, radio transceiver, sonar, laser ranger, altimeter, TCAS, ADS-B (Automatic dependent surveillance-broadcast) transponder. Optionally, the secondary computer system 302 may have controllers to control payload devices.

The UAV 100 illustrated in FIGS. 1-3 is an example provided for illustrative purposes. The UAV 100 in accordance with the present disclosure may include more or fewer components than are shown. For example, while a quadcopter is illustrated, the UAV 100 is not limited to any particular UAV configuration and may include hexacopters, octocopters, fixed wing aircraft, or any other type of independently maneuverable aircraft, as will be apparent to those of skill in the art having the benefit of the disclosure herein. Furthermore, the navigation of an autonomous UAV 100 may be guided by other types of vehicles (e.g., spacecraft, land vehicles, watercraft, submarine vehicles, etc.).

The following paragraphs describe a drone communication system with multi-modal connectivity and autonomous link management capabilities.

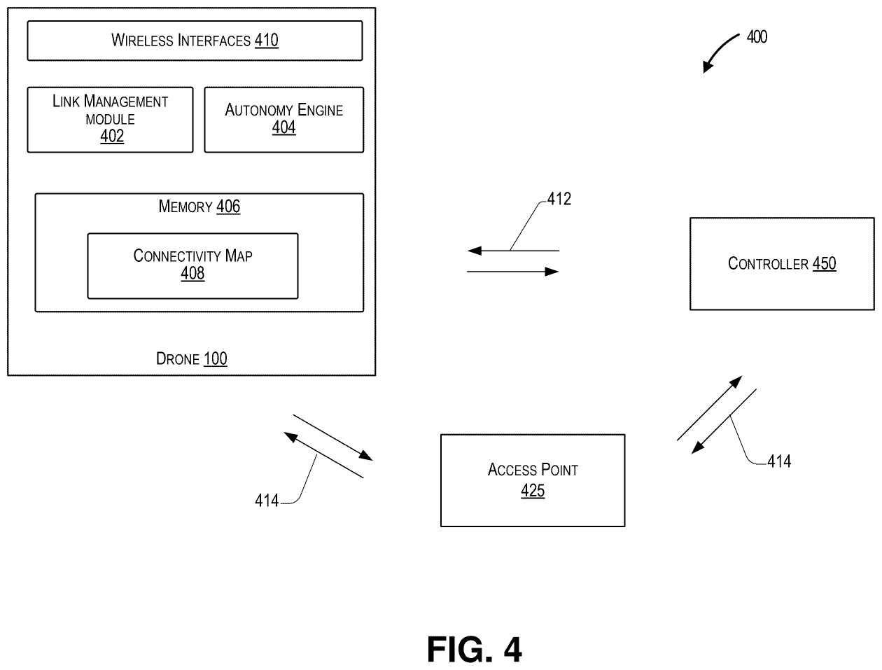

FIG. 4 illustrates a drone communication system 400 configured for multi-modal connectivity and autonomous mission management, consistent with various embodiments. In some embodiments, the drone 100 may include the UAV 100 of FIG. 1. The drone 100 includes multiple wireless interfaces 410, a link management module 402, an autonomy engine 404, and a memory 406. In some embodiments, the wireless interface includes one or more radio transceivers, such as the radio transceiver 359 of FIG. 3. In some embodiments, the memory 406 may be similar to the memory 318. In some embodiments, the link management module 402 and the autonomy engine 404 may be implemented as software modules, similar to the modules in the memory 316. Further, the link management module 402 and the autonomy engine 404 may be implemented as separate modules, or integrated with one or more modules in the memory 316.

The drone 100 is configured to communicate via at least two types of wireless interfaces 410. For example, a first wireless interface may be a P2P link, such as a Wi-Fi (e.g., 2.4 GHz or 5 GHz) or proprietary RF communication interface, and may be subject to line-of-sight constraints, and a second wireless interface may include a cellular link, such as 5G or LTE. The memory 406 stores a connectivity map 408, which comprises data representing expected wireless link quality across different geographic regions. In some embodiments, the connectivity map 408 may be generated from historical mission data, crowdsourced telemetry, or prior network scans, and may be updated dynamically during flight. The connectivity map 408 may include predicted or measured link quality metrics for both point-to-point (P2P) and cellular links, such as received signal strength indicator (RSSI), signal-to-noise ratio (SNR), latency, packet loss, bandwidth availability, and connection stability over time. In some embodiments, the wireless interfaces 410 are implemented using physically distinct communication modules, such as a Qualcomm-based LTE modem for 5G cellular and a Wi-Fi 6 chipset for P2P communication. These are managed by software routines executing on the drone's embedded computing platform (e.g., processor 335 and GPU 336), and use driver-level access to monitor signal metrics (e.g., RSSI, SNR) for both interfaces concurrently.

The link management module 402 is configured to evaluate available wireless interfaces on board the drone 100 and dynamically select between them based on real-time wireless link quality or the precomputed connectivity map 408. In some embodiments, when a degradation in a currently used link (e.g., P2P link) is detected during flight, the link management module 402 may switch from a P2P radio link to a cellular communication link or vice versa, depending on which provides better performance. For example, when the wireless link quality metric such as signal strength (RSSI) is below a specified threshold, the link management module 402 may switch to the cellular link provided the link quality metrics of the cellular link, such as the RSSI, is above a specified threshold. The wireless link 412 may represent either or both of a direct P2P wireless link or a cellular link between the drone 100 and the controller 450. The wireless link 414 represent P2P communication with one or more access points 425, which may act as relay stations to relay data between the drone 100 and the controller 450. The access point 425 may be connected to a WAN via Ethernet or satellite backhaul.

The access point 425 may serve as an intermediary node configured to relay data between the drone 100 and remote control infrastructure (e.g., controller 450) using a backhaul connection, such as an Ethernet or satellite interface. The access points 425 may be deployed in the field, independent of the operator's location, enabling greater physical separation between the operator and the drone to enhance operational safety, particularly in high-risk environments. The access points 425 may also be used to extend network coverage in areas with poor cellular connectivity, thereby increasing mission range and flexibility.

The controller 450 may be used by an operator to transmit control commands and receive data, such as telemetry or video data, from the drone 100. The controller 450 may also receive route updates, predicted signal quality information, and other telemetry based on decisions made by the autonomy engine 404. The access point 425 may be strategically placed to extend the communication range of the drone 100 or to provide connectivity in areas where direct line-of-sight to the controller 450 is unavailable or undesirable. In some embodiments, multiple access points 425 may be distributed throughout a city or operational area to create a coverage mesh, allowing the drone 100 to hop between available P2P links during flight.

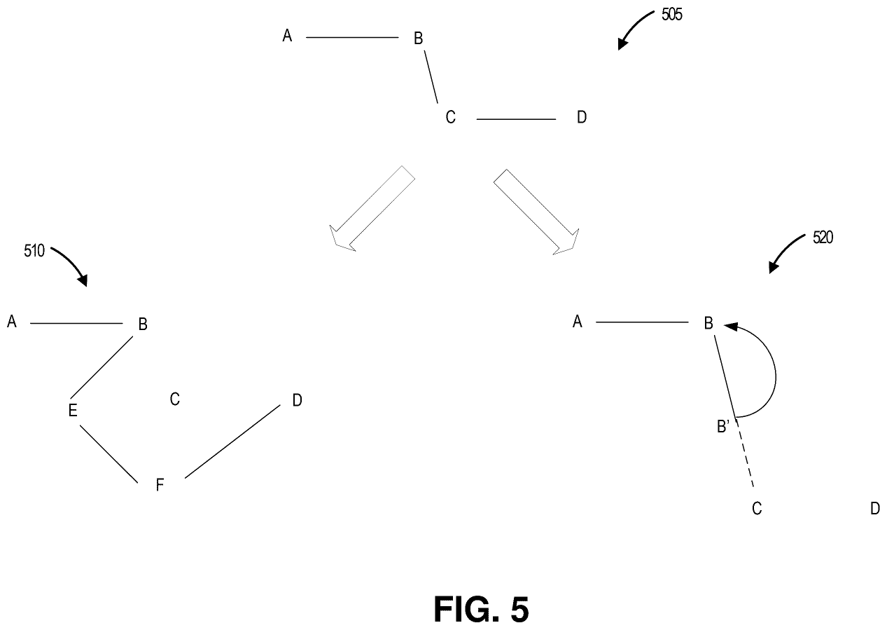

The autonomy engine 404 uses the connectivity map 408 not only to assist with link selection but also to plan the initial flight path. As illustrated in FIG. 5, the flight path 505 represents a path from an origin location A to a destination location D, selected based on expected link quality stored in the connectivity map 408. For example, if a direct route from A to D passes through regions with poor connectivity, the autonomy engine 404 may select a more circuitous route (e.g., through points B and C) that ensures consistent wireless communication, either through the P2P link or cellular link, throughout the mission. This proactive routing based on connectivity data increases the reliability of the system for applications such as surveillance, delivery, or emergency response. The autonomy engine 404 may also consider a mission objective in generating the flight path. In some embodiments, the mission objective may instruct the drone 100 to take the shortest flight path possible and avoid certain geographical regions (e.g., densely populated areas, locations with sky scrapers, etc.).

During flight, the autonomy engine 404 continues to monitor real-time wireless link metrics and may initiate various adaptive responses based on link quality or environmental conditions. For instance, as shown in FIG. 5, if the wireless link along flight path 505 degrades unexpectedly near point B (e.g., RSSI of P2P link and cellular link is below a threshold), the autonomy engine 404 may modify the flight path and redirect the drone 100 along an alternate trajectory such as path 510 through nodes E and F, where predicted connectivity is more favorable (e.g., RSSI of P2P link or cellular link is above the threshold). In another example illustrated in maneuver 520 of FIG. 5, the autonomy engine 404 may cause the drone 100 to initiate a backtrack maneuver upon losing connection near point B′ (e.g., RSSI of P2P link or cellular link near B′ is below a threshold for a specified period), returning from point B′ to a previous location B with known acceptable signal quality (e.g., RSSI of P2P link or cellular link near B is above the threshold for the specified period).

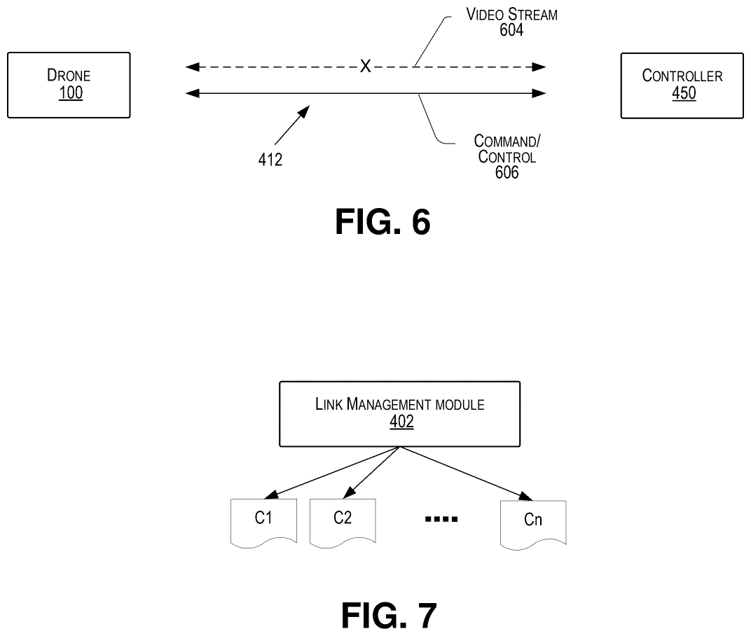

Additional adaptive responses may include suspending bandwidth-intensive communication from the drone 100, such as video transmission, while continuing to send command and control instructions, as shown in FIG. 6. In this case, the drone 100 may pause transmission of video stream 604 over the wireless link 412 due to insufficient bandwidth or increased packet loss, while maintaining command/control data 606 transmission. This ensures that operator control is preserved even during limited connectivity conditions, allowing the drone 100 to remain functional and avoid mission failure.

In some embodiments, the link management module 402 may also scan available RF channels during flight and dynamically select the channel based on the real-time link metrics, e.g., channel offering the least interference or highest quality. As shown in FIG. 7, the link management module 402 may evaluate multiple available channels C1 through Cn and select the optimal channel based on real-time interference metrics or congestion data. For example, when flying through a dense urban environment with substantial Wi-Fi congestion, the link management module 402 may switch to a less crowded channel to maintain video and telemetry performance.

These adaptive responses may be triggered by conditions such as a drop in RSSI to a value below a threshold, increase in packet loss to a value above a specified threshold, loss of video stream synchronization, latency above a specified threshold, or persistent communication failure with the controller 450 or access point 425. The integration of real-time link monitoring, autonomous decision-making, and multi-modal connectivity enables the system 400 to sustain mission operations in highly variable and constrained RF environments, providing increased resilience over traditional fixed-path, single-link UAV systems. In contrast to systems that treat connectivity loss as an external or post-facto exception (e.g., triggering only fail-safe returns), the disclosed system proactively integrates connectivity forecasts into flight planning at the trajectory generation stage. This fusion of connectivity awareness with mission logic allows for preemptive path adjustments and real-time mission continuity, particularly in constrained or contested RF environments.

In some embodiments, the autonomy engine 404 may incorporate a machine learning (ML) model trained to predict wireless link performance and generate optimized flight paths. The machine learning model may comprise a neural network trained on flight telemetry logs using supervised learning. Input features may include RSSI, SNR, GPS coordinates, altitude, airspeed, time of day, terrain class (urban/rural/vegetated), historical packet loss rate, and atmospheric conditions (e.g., humidity or temperature). The model may output a predicted link quality score, coverage degradation probability, or optimal path segment ranking. Training may be performed offline using a labeled dataset of flight records and connectivity outcomes, and inference may be performed onboard using lightweight neural inference on GPU 392 or processor 394. During a training phase, the model may be trained using historical mission data, including geographic location, altitude, RF interference patterns, network performance logs, environmental data such as weather conditions, and UAV telemetry. The model may learn to associate these features with observed link quality metrics to infer future connectivity expectations.

During inference, the trained ML model may be executed onboard the drone 100 to evaluate current and predicted flight conditions. For example, based on current GPS location, time of day, weather inputs, and prior knowledge encoded in the model, the autonomy engine 404 may forecast likely RF congestion or cellular blackouts along candidate paths. The model may then suggest alternate trajectories or preemptively modify the planned flight path to avoid areas of expected degradation. In another example, the model may assist in selecting between available wireless interfaces based on predicted signal strength or bandwidth availability.

Such ML-based predictions may enhance the robustness and adaptability of the system beyond rule-based approaches, allowing the drone 100 to learn from prior missions and generalize to new environments. The autonomy engine 404 may be periodically retrained using updated flight logs to improve performance over time.

FIG. 5 illustrates additional details of connectivity-aware flight path planning and adaptive rerouting, consistent with various embodiments. The planned flight path 505 connects origin point A to destination point D via points B and C. This path may be generated by the autonomy engine 404 based on a mission objective and using the connectivity map 408 stored onboard the drone 100, wherein each segment of the path corresponds to regions with expected acceptable wireless link quality. For example, in each segment of the flight path 505, the expected link quality metric of one or more of the wireless interfaces (e.g., RSSI of either P2P link or cellular link) is above a specified threshold.

In the event of real-time degradation in link quality, such as interference, reduced signal strength (e.g., RSSI below a specified threshold), or loss of signal, the autonomy engine 404 may reroute the drone 100 along the alternate flight path 510. The alternate flight path 510 passes through points E and F before reaching the destination location D. This detour may be executed autonomously in response to observed conditions such as signal strength falling below a threshold, excessive latency, or predicted dead zones. In the example of FIG. 5, the RSSI of both the P2P link and the cellular link between locations B and C is below a specified threshold, and therefore, the autonomy engine 404 determines the alternate flight path 510, which has improved or enhanced wireless connectivity, such as the RSSI of either the P2P link or the cellular link being above the specified threshold. The deviation improves mission resilience by maintaining uninterrupted communication with the controller or access points during flight.

In another example, as shown in maneuver 520, the autonomy engine 404 may also cause the drone 100 to perform a backtracking behavior by reversing from a degraded zone (e.g., B′) and returning to a last known location (e.g., B) with sufficient signal quality (e.g., the RSSI of either the P2P link or the cellular link being above the specified threshold). This backtracking approach is particularly useful when alternative forward paths are unavailable or when reestablishing the original link is prioritized. The decision to backtrack may be made based on factors such as control signal timeout, link instability (e.g., the RSSI of both the P2P link and the cellular link being below the specified threshold for a specified period), or predefined coverage thresholds encoded in the policy rules of the autonomy engine 404.

FIG. 6 illustrates an adaptive response mechanism in which a drone 100 modulates data transmission behavior based on available link conditions, consistent with some embodiments. The drone 100 and controller 450 are communicatively coupled via wireless link 412, such as at least one of P2P and cellular. A video stream 604 is shown as a dashed arrow, while a command/control data 606 is represented as a solid arrow.

During normal operation, both video stream 604 and command/control data 606 may be transmitted concurrently. However, in response to wireless link metric change, such as a drop in available bandwidth below a specified threshold, increased packet loss, or poor video streaming quality, the autonomy engine 404 or link management module 402 may suspend or throttle the video stream 604 while maintaining the command/control data 606 transmission. The symbol “X” on the video path represents the temporary suspension of the video stream 604. This selective transmission ensures that the drone 100 remains controllable and responsive to operator commands even when high-throughput video cannot be sustained. This behavior allows mission continuity under constrained link conditions without full disconnection or system failure.

FIG. 7 illustrates an example of dynamic channel selection performed by the link management module 402, consistent with various embodiments. The link management module 402 interfaces with a set of candidate wireless channels C1 through Cn, each of which may correspond to a distinct P2P wireless link channel within a frequency band such as 2.4 GHz or 5 GHz.

The link management module 402 may scan the wireless spectrum to evaluate each available channel based on metrics such as SNR, current interference levels, bandwidth availability, historical packet delivery performance, etc. In response to detecting congestion or link degradation (e.g., interference above a specified threshold) on the current operating channel, the link management module 402 may switch to a different channel (e.g., from C1 to C2) that offers improved performance. This decision may be executed in real-time during flight without interrupting command/control communication.

This dynamic channel switching improves overall link stability, extends usable range, and enhances video quality in environments with variable RF interference. In some embodiments, the channel selection process may be further informed by location-based data or predicted interference patterns derived from the connectivity map 408, allowing the drone 100 to anticipate and preempt link issues before they impact the mission.

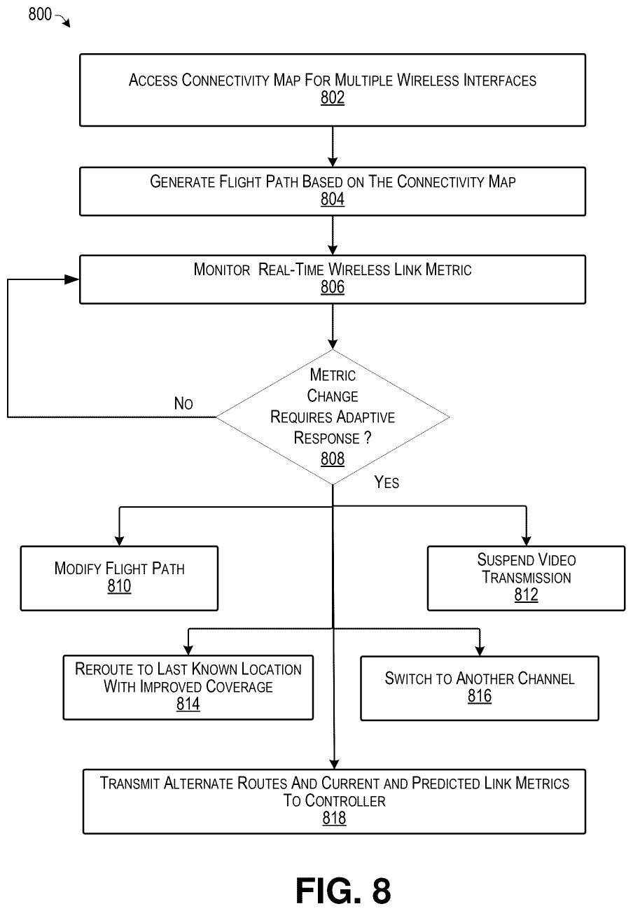

FIG. 8 is a flowchart illustrating a method 800 for connectivity-aware adaptive flight management, consistent with various embodiments. In some embodiments, the method 800 may be implemented using the drone communication system 400 of FIG. 4. At block 802, the autonomy engine 404 accesses the connectivity map 408 having link metrics for multiple wireless interfaces 410.

At block 804, the autonomy engine 404 generates a flight path 505 based on the connectivity map 408, taking into account the predicted signal quality across geographic regions.

At block 806, the autonomy engine 404 continues to monitor real-time wireless link metrics during flight. This process may involve the integration of real-time connectivity awareness into the mission logic of the drone 100, which may be facilitated by the autonomy engine 404. The wireless communication interfaces may include P2P links and cellular links, such as 5G or LTE links. The continuous monitoring of link metrics may be essential for ensuring connectivity continuity, as it may allow the communication system to detect any degradation or disconnection in the communication links. The monitoring process may involve assessing the quality of the links and aiding the autonomy engine 404 to respond to any changes in the link quality. This capability may be crucial for maintaining strong connectivity and avoiding areas with suboptimal coverage. The integration of real-time connectivity awareness into the mission logic may enable the drone 100 to anticipate potential connectivity issues and take proactive measures to address them. This step may be part of a broader strategy of the system that may adjust flight plans based on signal quality to ensure connectivity continuity. The continuous monitoring of link quality may be a foundational aspect of the drone communication system 400, allowing it to maintain optimal communication with the operator and other systems.

At decision block 808, the autonomy engine 404 determines whether a change in wireless link metrics requires an adaptive response. An adaptive response may be required if the measured signal strength (e.g., RSSI) drops below a specified minimum threshold, packet loss exceeds an acceptable rate, video streaming becomes unsustainable, bandwidth is less than a specified minimum threshold, latency exceeds a specified threshold, interference is above a specified threshold, or the predicted reliability of the current link path deteriorates based on real-time conditions. Conversely, if the link quality remains within acceptable thresholds, with stable bandwidth and low latency, no adaptive response is triggered.

If an adaptive response is required, the autonomy engine 404 may execute one or more actions, such as those described in blocks 810-818. For example, at block 810, the autonomy engine 404 may modify the flight path to avoid areas of degraded connectivity, as described at least with reference to alternate flight path 510 of FIG. 5. The autonomy engine 404 may adjust flight paths based on link metrics, thereby ensuring connectivity continuity by anticipating signal loss and acting before disruption. The autonomy engine 404 may cause the drone 100 to navigate to locations with optimal signal strength (e.g., RSSI above a specified threshold). The drone's ability to dynamically alter its flight path may be crucial for optimizing connectivity, as it may allow the drone 100 to respond to connection degradation by autonomously altering its route to maintain communication. This capability may be supported by the integration of real-time awareness of the link metrics into the drone's mission logic, which may be continuously monitored by the autonomy engine 404. Overall, the drone's ability to dynamically alter its flight path to avoid suboptimal coverage may enable the drone 100 to maintain strong connectivity and optimize data flow during its mission.

In another example, at block 812, the autonomy engine 404 may suspend video transmission while maintaining command/control link integrity when a bandwidth is below a threshold, as described at least with reference to FIG. 6. This adaptation may ensure that essential command and control communications are maintained even when video streaming is suspended. The operator may receive real-time updates regarding the connectivity status, which can aid in manual missions by providing insights into the current and projected coverage status. The drone's capability to adapt data transmission based on bandwidth availability may enhance its overall connectivity management and ensure continuous communication with the operator.

In yet another example, at block 814, the autonomy engine 404 may reroute the drone 100 to a last known location with improved coverage, as described at least with reference to maneuver 520 of FIG. 5.

In yet another example, at block 816, the link management module 402 may perform channel scanning (e.g., in a P2P link) and switch to a less congested RF channel, as described at least with reference to FIG. 7. The link management module 402 may continuously assess the wireless spectrum, which may involve evaluating various parameters such as signal interference and quality metrics. The link management module 402 may then adaptively select an optimal channel in real-time, which may be based on the aforementioned parameters. The link management module 402 may be designed to dynamically shift to the optimal channel, thereby potentially enhancing the drone's ability to maintain robust communication links. This capability may be particularly beneficial in environments where signal interference is prevalent, as it may allow the drone to navigate through such challenges by selecting channels that offer better quality and less interference. The dynamic channel selection process aims to provide seamless and reliable communication throughout its operations.

In some embodiments, the drone 100 may be operated non-autonomously, that is, manually by an operator using the controller 450. In such missions, at block 818, the autonomy engine 404 may transmit updated alternate routes or current and predicted link metrics to the controller 450 for operator awareness. The transmitted data may be displayed on a display associated with the controller 450 via a graphical user interface. This allows the operator to remain informed of connectivity conditions and system decisions, and to intervene if needed. In some implementations, the graphical user interface on the controller 450 may include a visual overlay of predicted connectivity along the flight path, using data retrieved from the connectivity map 408. The UI may provide a segmented heatmap showing signal strength bands (e.g., green=strong, yellow=marginal, red=no coverage), allowing the operator to manually override rerouting decisions or approve recommendations provided by the autonomy engine 404.

These responses may occur independently or in combination, depending on the specific link degradation scenario.

The disclosed drone communication system 400 provides significant advantages over prior art UAV communication architectures by integrating multi-modal wireless interfaces with real-time autonomy-driven decision making. Unlike traditional systems that rely solely on static P2P links or operator-dependent routing, the drone communication system 400 enables seamless transitions between multiple wireless networks, such as P2P (e.g., Wi-Fi network) and cellular communication, ensuring persistent connectivity across diverse and challenging environments. The inclusion of a dynamic connectivity map, ML-based predictive modeling, and adaptive in-flight responses, such as route modification, channel switching, and selective data suspension, further enhances operational resilience. These capabilities allow UAVs to maintain robust control and data links, extend mission range, reduce the likelihood of disconnection, and support fully autonomous operations, especially in public safety, defense, and infrastructure monitoring scenarios where uninterrupted communication is critical.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

Persons skilled in the art will understand that the various embodiments of the present disclosure and shown in the accompanying figures constitute non-limiting examples, and that additional components and features may be added to any of the embodiments discussed hereinabove without departing from the scope of the present disclosure. Additionally, persons skilled in the art will understand that the elements and features shown or described in connection with one embodiment may be combined with those of another embodiment without departing from the scope of the present disclosure to achieve any desired result and will appreciate further features and advantages of the presently disclosed subject matter based on the description provided. Variations, combinations, and/or modifications to any of the embodiments and/or features of the embodiments described herein that are within the abilities of a person having ordinary skill in the art are also within the scope of the present disclosure, as are alternative embodiments that may result from combining, integrating, and/or omitting features from any of the disclosed embodiments.

Use of the term “optionally” with respect to any element of a claim means that the element may be included or omitted, with both alternatives being within the scope of the claim. Additionally, use of broader terms such as “comprises,” “includes,” and “having” should be understood to provide support for narrower terms such as “consisting of,” “consisting essentially of,” and “comprised substantially of.” Accordingly, the scope of protection is not limited by the description set out above, but is defined by the claims that follow, and includes all equivalents of the subject matter of the claims.

In the preceding description, reference may be made to the spatial relationship between the various structures illustrated in the accompanying drawings, and to the spatial orientation of the structures. However, as will be recognized by those skilled in the art after a complete reading of this disclosure, the structures described herein may be positioned and oriented in any manner suitable for their intended purpose. Thus, the use of terms such as “above,” “below,” “upper,” “lower,” “inner,” “outer,” “left,” “right,” “upward,” “downward,” “inward,” “outward,” “horizontal,” “vertical,” etc., should be understood to describe a relative relationship between the structures and/or a spatial orientation of the structures. Those skilled in the art will also recognize that the use of such terms may be provided in the context of the illustrations provided by the corresponding figure(s).

Additionally, terms such as “approximately,” “generally,” “substantially,” and the like should be understood to allow for variations in any numerical range or concept with which they are associated and encompass variations on the order of 25% (e.g., to allow for manufacturing tolerances and/or deviations in design). For example, the term “generally parallel” should be understood as referring to configurations in with the pertinent components are oriented so as to define an angle therebetween that is equal to 180°±25% (e.g., an angle that lies within the range of (approximately) 135° to (approximately)) 225°. The term “generally parallel” should thus be understood as referring to encompass configurations in which the pertinent components are arranged in parallel relation.

Although terms such as “first,” “second,” “third,” etc., may be used herein to describe various operations, elements, components, regions, and/or sections, these operations, elements, components, regions, and/or sections should not be limited by the use of these terms in that these terms are used to distinguish one operation, element, component, region, or section from another. Thus, unless expressly stated otherwise, a first operation, element, component, region, or section could be termed a second operation, element, component, region, or section without departing from the scope of the present disclosure.

As used herein, unless specifically stated otherwise, the term “or” encompasses all possible combinations, except where infeasible. For example, if it is stated that a component includes A or B, then, unless specifically stated otherwise or infeasible, the component may include only A, or only B, or A and B. As a second example, if it is stated that a component includes A, B, or C, then, unless specifically stated otherwise or infeasible, the component may include only A, or only B, or only C, or A and B, or A and C, or B and C, or A and B and C. Expressions such as “at least one of” do not necessarily modify an entirety of a following list and do not necessarily modify each member of the list, such that “at least one of A, B, and C” should be understood as including only A, or only B, or only C, or any combination of A, B, and C. The phrase “one of A and B” or “any one of A and B” shall be interpreted in the broadest sense to include one of A, or one of B.

The descriptions herein are intended to be illustrative, not limiting. Thus, it will be apparent to one skilled in the art that modifications may be made as described without departing from the scope of the claims set out below.

The present techniques will be better understood with reference to the following enumerated embodiments:

1. A drone communication system comprising:
a radio transceiver configured for point-to-point wireless communication;
a cellular modem configured to communicate via a wide-area cellular network;
a link management module configured to dynamically select between the radio transceiver and the cellular modem based on link quality metrics during flight; and
a fusion controller configured to enable seamless transition of data and control signals between the radio transceiver and the cellular modem without interrupting command or video streams.

2. The system of any of the preceding embodiments, wherein the fusion controller preserves control and telemetry channels during a switch between connectivity modes.

3. The system of any of the preceding embodiments, wherein the fusion controller suspends video streaming while maintaining control and telemetry during degraded bandwidth conditions.

4. The system of any of the preceding embodiments, wherein the link management module performs dynamic RF channel selection based on interference scans during flight.

5. The system of any of the preceding embodiments, wherein the drone maintains simultaneous connections with both the radio transceiver and the cellular modem and prioritizes based on latency or signal-to-noise ratio.

6. The system of any of the preceding embodiments, wherein the cellular modem supports connection to multiple carriers with fallback redundancy.

7. The system of any of the preceding embodiments, further comprising a user interface that displays current and predicted link status along the planned mission route.

8. The system of any of the preceding embodiments, wherein the drone includes an onboard cache that buffers video and data during transitions between network links.

9. A drone communication infrastructure comprising:
a drone equipped with a point-to-point radio transceiver;
a ground controller; and
one or more remote access points, each comprising:
   a radio interface configured to communicate with the drone;
   a backhaul interface coupled to a wide-area network via Ethernet or satellite;
wherein the access points are configured to relay command-and-control data and video streams between the drone and the ground controller, and wherein the drone autonomously associates with a proximate access point during flight based on signal strength and connectivity availability.

10. The infrastructure of any of the preceding embodiments, wherein the access point includes a deployable antenna selected based on terrain or mission type.

11. The infrastructure of any of the preceding embodiments, wherein the access point is connected to a satellite backhaul for global reach.

12. The infrastructure of any of the preceding embodiments, wherein the access point is configured to operate autonomously without a local controller.

13. The infrastructure of any of the preceding embodiments, wherein the drone switches between access points during flight without reauthentication or session loss.

14. The infrastructure of any of the preceding embodiments, wherein a plurality of access points are deployed in a mesh configuration to provide redundant coverage in urban or rural zones.

15. An autonomous unmanned aerial vehicle (UAV) comprising:
a point-to-point radio module and a cellular modem;
a memory storing a connectivity map indicating expected signal coverage across geographic regions; and
an autonomy engine configured to:
   plan a flight route based on a mission objective and the connectivity map;
   monitor real-time connectivity quality during flight;
   dynamically reroute the UAV to maintain communication by avoiding regions of low signal quality; and
   backtrack to a known coverage area upon loss of both point-to-point and cellular communication links for a predefined duration.

16. The autonomous UAV of any of the preceding embodiments, wherein the connectivity map is generated from crowdsourced or historical flight data.

17. The autonomous UAV of any of the preceding embodiments, wherein the UAV autonomously recommends alternate routes to a human operator based on real-time signal conditions.

18. The autonomous UAV of any of the preceding embodiments, wherein the autonomy engine suspends mission tasks and initiates return-to-home upon prolonged link failure.

19. The autonomous UAV of any of the preceding embodiments, wherein the UAV transmits its real-time connectivity status to a control station for operator awareness.

20. The autonomous UAV of any of the preceding embodiments, wherein the autonomy engine uses a machine learning model to predict coverage degradation based on environmental conditions.

21. An autonomous drone system comprising:
one or more radio communication modules;
a memory storing a connectivity map comprising expected signal quality across geographic regions; and
an autonomy engine configured to:
   plan a flight route based on a mission objective;
   modify the flight route to avoid regions of low connectivity based on the connectivity map; and
   autonomously reroute the drone upon detecting degraded signal conditions during flight.

22. The system of any of the preceding embodiments, wherein the connectivity map is generated using crowdsourced or historical flight data.

23. The system of any of the preceding embodiments, wherein rerouting occurs when a connection threshold is breached.

24. The system of any of the preceding embodiments, further comprising a user interface for displaying signal-aware route recommendations to an operator.

25. The system of any of the preceding embodiments, wherein the drone autonomously returns to a known coverage area if no link is available for a threshold period.

26. The system of any of the preceding embodiments, wherein the autonomy engine uses machine learning to predict future coverage conditions based on environmental factors.

27. A method for managing a drone mission, comprising:
generating or accessing a connectivity map of a geographic area;
determining a flight route based on a mission goal and the connectivity map;
autonomously altering the route to avoid areas with poor connectivity; and
upon detecting connection degradation, autonomously modifying the flight path to maintain communication.

28. A method for autonomous connectivity management in a drone, comprising:
integrating, by an onboard autonomy engine of the drone, real-time connectivity awareness into a mission logic of the drone;
continuously monitoring, by the onboard autonomy engine, link quality across a plurality of wireless communication interfaces;
adjusting, by an AI module of the drone, flight plans based on at least one of pre-known signal quality or real-time signal quality to ensure connectivity continuity by anticipating signal loss and acting before disruption;
autonomously navigating, by the drone, to locations with optimal signal strength;
dynamically altering, by the drone, a flight path to avoid areas with suboptimal coverage;
adapting, by the drone, data transmission based on available bandwidth; and
providing, by the drone, real-time updates to an operator regarding at least one of current connectivity status or projected connectivity status.

29. The method of any of the preceding embodiments, wherein the plurality of wireless communication interfaces comprises at least one of radio frequency (RF) links or cellular links.

30. The method of any of the preceding embodiments, wherein the cellular links comprise at least one of 5G links or LTE links.

31. The method of any of the preceding embodiments further comprising:
fusing, by a multi-modal connectivity architecture of the drone, the plurality of wireless communication interfaces.

32. The method of any of the preceding embodiments further comprising:
continuously assessing, by a dynamic channel selector of the drone, a wireless spectrum; and
adaptively selecting, by the dynamic channel selector, an optimal channel in real-time based on at least one of signal interference or quality parameters.

33. The method of any of the preceding embodiments, wherein autonomously navigating the drone to locations with optimal signal strength comprises:
autonomously backtracking, by the drone, to a last known location with strong signal strength.

34. The method of any of the preceding embodiments, wherein adapting data transmission based on available bandwidth comprises at least one of:
suspending video streaming while retaining command and control when bandwidth is limited; or informing the operator of current and projected coverage status in manual missions.

35. The method of any of the preceding embodiments, wherein the AI module is further configured to provide smart decision-making and fallback in poor coverage areas.

36. The method of any of the preceding embodiments further comprising:
enabling, by a connectivity fusion module of the drone, seamless switching between the plurality of wireless communication interfaces.

37. The method of any of the preceding embodiments further comprising:
facilitating, by remote wireless modules, extension of connectivity to the drone; and enabling, by the remote wireless modules, the operator to maintain a safe distance from the drone, particularly in hazardous environments.

38. A drone comprising:
an onboard autonomy engine configured to:
   integrate real-time connectivity awareness into a mission logic of the drone; and
   continuously monitor link quality across a plurality of wireless communication interfaces;
an AI module configured to adjust flight plans based on at least one of pre-known signal quality or real-time signal quality to ensure connectivity continuity by anticipating signal loss and acting before disruption; and
a controller configured to:
   autonomously navigate the drone to locations with optimal signal strength;
   dynamically alter a flight path of the drone to avoid areas with suboptimal coverage;
   adapt data transmission based on available bandwidth; and
   provide real-time updates to an operator regarding at least one of current connectivity status or projected connectivity status.

39. The drone of any of the preceding embodiments, wherein the plurality of wireless communication interfaces comprises at least one of radio frequency (RF) links or cellular links.

40. The drone of claim 9, wherein the cellular links comprise at least one of 5G links or LTE links.

41. The drone of any of the preceding embodiments further comprising:
a multi-modal connectivity architecture configured to fuse the plurality of wireless communication interfaces.

42. The drone of any of the preceding embodiments further comprising:
a dynamic channel selector configured to:
   continuously assess a wireless spectrum; and
   adaptively select an optimal channel in real-time based on at least one of signal interference or quality parameters.

43. The drone of any of the preceding embodiments, wherein the controller is further configured to:
autonomously backtrack the drone to a last known location with strong signal strength.

44. The drone of any of the preceding embodiments, wherein the controller is further configured to adapt data transmission based on available bandwidth by at least one of:
suspending video streaming while retaining command and control when bandwidth is limited; or
informing the operator of current and projected coverage status in manual missions.

45. The drone of any of the preceding embodiments, wherein the AI module is further configured to provide smart decision-making and fallback in poor coverage areas.

46. The drone of any of the preceding embodiments further comprising:
a connectivity fusion module configured to enable seamless switching between the plurality of wireless communication interfaces.

47. The drone of any of the preceding embodiments further comprising:
remote wireless modules configured to:
facilitate extension of connectivity to the drone; and enable the operator to maintain a safe distance from the drone, particularly in hazardous environments.

48. A tangible, non-transitory, machine-readable medium storing instructions that, when executed by a data processing apparatus, cause the data processing apparatus to perform operations comprising those of any of embodiments 1-47.

49. A system comprising: one or more processors; and memory storing instructions that, when executed by the processors, cause the processors to effectuate operations comprising those of any of embodiments 1-47.

50. A system comprising means for performing any of embodiments 1-47.

What is claimed is:

1. A drone communication system, comprising:
a drone with multiple wireless communication interfaces;
a memory storing a connectivity map having expected wireless link quality across geographic regions for the wireless communication interfaces;
a link management module configured to:
dynamically select between the wireless communication interfaces based on at least one of the connectivity map or real-time wireless link quality during flight; and
an autonomy engine onboard the drone configured to:
plan a flight path based on the connectivity map,
monitor real-time wireless link quality during flight, and
modify the flight path during flight in response to detecting a wireless connectivity in a region is below a specified threshold.

2. The drone communication system of claim 1, wherein the wireless communication interfaces include a point-to-point (P2P) wireless link and a cellular link.

3. The drone communication system of claim 2, wherein the P2P wireless link includes a Wi-Fi link and the cellular link includes a 5G or LTE link.

4. The drone communication system of claim 1, wherein the wireless connectivity is below the specified threshold when the wireless link quality of each of the wireless communication interfaces is below their corresponding specified threshold.

5. The drone communication system of claim 1, wherein the link management module is configured to:
monitor a wireless spectrum associated with a P2P wireless link; and
select a communication channel from a set of communication channels in real-time based on one or more of interference, bandwidth availability or link quality.

6. The drone communication system of claim 1, wherein the autonomy engine is configured to:
navigate the drone to a last known location with improved wireless connectivity in response to detecting the wireless connectivity is below the specified threshold for a specified period.

7. The drone communication system of claim 1, wherein the autonomy engine is configured to:
suspend video streaming while retaining transmission of command or control instructions in response to detecting the wireless link quality is below a specified threshold.

8. The drone communication system of claim 1, wherein the autonomy engine is configured to:
transmit the real-time wireless link quality and predicted wireless link quality along the flight path to a controller device for display via a graphical user interface.

9. The drone communication system of claim 1, wherein the autonomy engine is configured to:
detect the wireless connectivity is below the specified threshold, and
transmit alternate flight paths with predicted improved wireless connectivity to a controller device for display via a graphical user interface.

10. The drone communication system of claim 1, wherein the autonomy engine uses a machine learning model that is trained to predict wireless link quality based on environmental conditions.

11. The drone communication system of claim 1 further comprising:
multiple remote access points that are configured to provide wireless connectivity to the drone.

12. The drone communication system of claim 11, wherein the remote access points are connected to a network via Ethernet or satellite.

13. The drone communication system of claim 11, wherein the remote access points are configured to relay command-and-control data and video streams between the drone and a ground controller, and wherein the drone autonomously associates with a proximate access point during flight based on wireless link strength and availability of wireless connectivity.

14. A method for managing a drone mission based on wireless connectivity, the method comprising:
accessing, from a memory onboard a drone, a connectivity map having expected wireless link coverage across geographic regions for a plurality of wireless communication interfaces on the drone;
generating, by an autonomy engine on board the drone, a flight path based on the connectivity map;
automatically switching between the wireless communication interfaces during flight based on the connectivity map or real-time wireless link quality; and
modifying the flight path in response to detecting that a wireless connectivity in a region along the flight path is below a specified threshold.

15. The method of claim 14 further comprising:
navigating, by the autonomy engine, the drone to a last known location with improved wireless connectivity in response to detecting the wireless connectivity is below the specified threshold for a specified period.

16. The method of claim 14 further comprising:
suspending video streaming from the drone while retaining transmission of command or control instructions in response to detecting the wireless link quality is below a specified threshold.

17. The method of claim 14 further comprising:
monitoring a wireless spectrum associated with a point-to-point wireless communication interface; and
selecting a communication channel from a set of communication channels in real-time based on one or more of interference, bandwidth availability or link quality.

18. An autonomous unmanned aerial vehicle (UAV) comprising:
a point-to-point (P2P) wireless radio transceiver and a cellular transceiver;
a memory storing a connectivity map indicating expected wireless link coverage across geographic regions; and
an autonomy engine configured to:
plan a flight path based on a mission objective and the connectivity map,
monitor real-time wireless link quality during flight,
dynamically reroute the UAV to maintain wireless connectivity by avoiding regions with the wireless link quality below a specified threshold, and
in response to loss of both P2P wireless link and cellular wireless link for a predefined duration, backtrack the UAV to a last known location with the wireless link quality above the specified threshold.

19. The autonomous UAV of claim 18 further comprising:
a link management module configured to:
maintain both the P2P wireless link and the cellular wireless link, and
dynamically switch between the P2P wireless link and the cellular wireless link based on at least one of the connectivity map or real-time wireless link quality during flight.

20. The autonomous UAV of claim 19, wherein the link management module is configured to:
monitor a wireless spectrum associated with the P2P wireless link, and
select a communication channel from a set of communication channels in real-time based on one or more of interference, bandwidth availability or link quality.
